(19) United States
(12) Patent Application Publication
(10) Pub. No.: US 2026/0368072 A1
(43) Pub. Date: Nov. 19, 2026

(54) METHOD, APPARATUS, SYSTEM AND COMPUTER PROGRAM FOR GENERATING TEST CODE USING HYBRID ANALYSIS

(71) Applicants: SAMSUNG SDS Co., Ltd., Seoul (KR); Korea University Research and Business Foundation, Seoul (KR)

(72) Inventors: Seokhyeon MUN, Seoul (KR); Yoonchan JHI, Seoul (KR); Hakjoo OH, Seoul (KR); Myungho LEE, Seoul (KR); Jiseong BAK, Seoul (KR)

(73) Assignees: SAMSUNG SDS Co., Ltd., Seoul (KR); Korea University Research and Business Foundation, Seoul (KR)

(21) Appl. No.: 19/348,394

(22) Filed: Oct. 2, 2025

(30) Foreign Application Priority Data
Oct. 10, 2024 (KR) 10-2024-0137854

(51) Int. Cl. G06F 11/3668

(52) U.S. Cl. CPC G06F 11/3684

(57) ABSTRACT

The present disclosure relates to a method, apparatus, system, and computer program for generating a test code based on static analysis and dynamic analysis. More particularly, the present disclosure discloses a method for generating a test code using a computing device that includes: calculating a first error likelihood score for one or more functions included in an analysis target program through static analysis of the analysis target program; calculating a second error likelihood score for one or more test codes, based on a result of dynamic analysis using the one or more test codes corresponding to the analysis target program and the first error likelihood score; and generating one or more mutated test codes using a test code selected based on the second error likelihood score from among the one or more test codes.

### CROSS-REFERENCE TO RELATED APPLICATION(S)

This application is based on and claims priority under 35 U.S.C. 119 to Korean Patent Application No. 10-2024-0137854, filed on Oct. 10, 2024, in the Korean Intellectual Property Office, the disclosure of which is herein incorporated by reference in its entirety.

### BACKGROUND OF THE INVENTION

### 1. Field of the Invention

The present disclosure relates to a method, apparatus, system, and computer program for generating a test code using hybrid analysis and, more particularly, to a method, apparatus, system, and computer program for generating a test code using hybrid analysis that are capable of efficiently generating a test code for an analysis target program, based on static analysis and dynamic analysis techniques.

### 2. Description of the Prior Art

With the recent proliferation of various information and communication services, techniques for efficiently testing various pieces of software are being attempted.

Various techniques are being used to generate a test code and to perform a test for inspecting each unit forming software in a software development process.

Conventionally, testing is generally performed for grammatical or logical errors with respect to code coverage, in which case it is possible to efficiently detect a simple error, such as a grammatical error, but a vulnerability detection capability for an error like an NPE may stagnate instead of improving proportionally to an increase in code coverage, or may rather deteriorate even with an increase in code coverage.

Furthermore, even though performing static analysis based on a source code for an analysis target program or dynamic analysis of the analysis target program based on a generated test code according to a conventional technology, only vulnerability detection results according to each of the static analysis and the dynamic analysis may be obtained, but it is difficult to efficiently detect vulnerabilities of the analysis target program by using the static analysis and the dynamic analysis at the same time.

Accordingly, there is a need for a method for generating a test code, which is capable of more efficiently detecting an error in an analysis target program in a software development process, but an appropriate solution has not yet been presented.

### PATENT DOCUMENT

KR Patent Publication No. 10-2012-0063796 (Jun. 18, 2012)

### SUMMARY OF THE INVENTION

The present disclosure has been made in order to solve the above-mentioned problems in the prior art, and an aspect of the present disclosure is to provide a method, apparatus, system, and computer program for generating a test code that are capable of efficiently generating a test code for detecting a vulnerability of an analysis target program.

Further, an aspect of the present disclosure is to provide a method, apparatus, system, and computer program for generating a test code that are capable of resolving stagnation or deterioration in vulnerability detection capability for an error, such as an NPE, even though code coverage increases.

In addition, an aspect of the present disclosure is to provide a method, apparatus, system, and computer program for generating a test code that are capable of efficiently detecting a vulnerability of an analysis target program by using static analysis and dynamic analysis at the same time.

Technical problems to be solved by the present disclosure are not limited to the technical aspects mentioned above, and other technical aspects not mentioned will be clearly understood by those skilled in the art from a description of the present disclosure.

According to a first embodiment of the present disclosure, a method for generating a test code using a computing device may include: calculating a first error likelihood score for one or more functions included in an analysis target program through static analysis of the analysis target program; calculating a second error likelihood score for one or more test codes, based on a result of dynamic analysis using the one or more test codes corresponding to the analysis target program and the first error likelihood score; and generating one or more mutated test codes using a test code selected based on the second error likelihood score from among the one or more test codes.

The calculating of the first error likelihood score may include: calculating one or more candidate paths for reaching a location of an expression likely to cause an error for the one or more functions; selecting a path likely to cause an error in which occurrence of an error is possible in a case of reaching the expression via the one or more candidate paths; and deriving the first error likelihood score for the one or more functions, based on the candidate paths and the path likely to cause the error.

The calculating of the one or more candidate paths may include: identifying the expression likely to cause the error for the one or more functions; and deriving the one or more candidate paths for reaching the location of the expression likely to cause the error, based on a control flow graph (CFG) for the analysis target program.

The deriving of the one or more candidate paths may derive the one or more candidate paths by tracing the control flow graph backwards, based on the location of the expression likely to cause the error.

The selecting of the path likely to cause the error may select the path likely to cause the error by determining whether an error occurs while executing each statement along the one or more candidate paths.

The deriving of the first error likelihood score may include: calculating a path-based error likelihood score for the one or more functions, based on a ratio of the path likely to cause the error among the candidate paths; and calculating the first error likelihood score for the functions by adding the path-based error likelihood score for the one or more functions and a path-based error likelihood score for a called function called from the functions.

The calculating of the second error likelihood score may calculate the second error likelihood score by adding respective first error likelihood scores for one or more functions called from the dynamic analysis using the one or more test codes.

The generating of the mutated test codes may generate the mutated test codes selected with a high probability in proportion to the second error likelihood score for each of the one or more test codes.

The generating of the mutated test codes may identify a variable or a statement associated with error occurrence through static analysis of the one or more test codes, and generate the mutated test codes by selecting the identified variable or statement based on a probability.

The generating of the mutated test codes repeatedly may generate the mutated codes, based on the second error likelihood score by repeatedly performing dynamic analysis based on the mutated test codes.

According to a second embodiment of the present disclosure, an apparatus for generating a test code may include a processor; and a memory, wherein the memory may include an instruction configured, when executed by the processor, to enable the apparatus to implement a specific operation, and the specific operation may include: calculating a first error likelihood score for one or more functions included in an analysis target program through static analysis of the analysis target program; calculating a second error likelihood score for one or more test codes, based on a result of dynamic analysis using the one or more test codes corresponding to the analysis target program and the first error likelihood score; and generating one or more mutated test codes using a test code selected based on the second error likelihood score from among the one or more test codes.

The calculating of the first error likelihood score may include: calculating one or more candidate paths for reaching a location of an expression likely to cause an error for the one or more functions; selecting a path likely to cause an error in which occurrence of an error is possible in a case of reaching the expression via the one or more candidate paths; and deriving the first error likelihood score for the one or more functions, based on the candidate paths and the path likely to cause the error.

The calculating of the one or more candidate paths may include: identifying the expression likely to cause the error for the one or more functions; and deriving the one or more candidate paths for reaching the location of the expression likely to cause the error, based on a control flow graph (CFG) for the analysis target program.

The deriving of the one or more candidate paths may derive the one or more candidate paths by tracing the control flow graph backwards, based on the location of the expression likely to cause the error.

The selecting of the path likely to cause the error may select the path likely to cause the error by determining whether an error occurs while executing each statement along the one or more candidate paths.

The deriving of the first error likelihood score may include: calculating a path-based error likelihood score for the one or more functions, based on a ratio of the path likely to cause the error among the candidate paths; and calculating the first error likelihood score for the functions by adding the path-based error likelihood score for the one or more functions and a path-based error likelihood score for a called function called from the functions.

The calculating of the second error likelihood score may calculate the second error likelihood score by adding respective first error likelihood scores for one or more functions called from the dynamic analysis using the one or more test codes.

The generating of the mutated test codes may identify a variable or a statement associated with error occurrence through static analysis of the one or more test codes, and may generate the mutated test codes by selecting the identified variable or statement based on a probability.

The generating of the mutated test codes may repeatedly generate the mutated codes, based on the second error likelihood score by repeatedly performing dynamic analysis based on the mutated test codes.

According to a third embodiment of the present disclosure, a computer-readable storage medium may store instructions configured, when executed by a processor, to enable an apparatus for generating a test code that includes the processor to implement a specific operation, wherein the specific operation may include: calculating a first error likelihood score for one or more functions included in an analysis target program through static analysis of the analysis target program; calculating a second error likelihood score for one or more test codes, based on a result of dynamic analysis using the one or more test codes corresponding to the analysis target program and the first error likelihood score; and generating one or more mutated test codes using a test code selected based on the second error likelihood score from among the one or more test codes.

Accordingly, a method, apparatus, system, and computer program for generating a test code by using hybrid analysis according to an embodiment of the present disclosure may efficiently generate a test code for detecting a vulnerability of an analysis target program.

Further, a method, apparatus, system, and computer program for generating a test code by using hybrid analysis according to an embodiment of the present disclosure may resolve stagnation or deterioration in vulnerability detection capability for an error, such as an NPE, even though code coverage increases.

In addition, a method, apparatus, system, and computer program for generating a test code by using hybrid analysis according to an embodiment of the present disclosure may efficiently detect a vulnerability of an analysis target program by using static analysis and dynamic analysis at the same time.

Effects obtainable from the present disclosure are not limited to the effects mentioned above, and other effects not mentioned will be clearly understood by those skilled in the art to which the present disclosure pertains from a description of the present disclosure.

### BRIEF DESCRIPTION OF THE DRAWINGS

The accompanying drawings, which are included as a part of the detailed description to help the understanding of the present disclosure, provide embodiments of the present disclosure and describe the technical spirit of the present disclosure in conjunction with the detailed description, in which:

FIG. 1 illustrates the configuration of a test code generation system according to an embodiment of the present disclosure;

FIG. 2 is a flowchart illustrating a test code generation method according to an embodiment of the present disclosure;

FIG. 3 illustrates the configuration and operation of a test code generation apparatus according to an embodiment of the present disclosure;

FIG. 4 is a flowchart specifically illustrating an operation of calculating a first error likelihood score according to an embodiment of the present disclosure;

FIG. 5 is a flowchart specifically illustrating an operation of calculating one or more candidate paths according to an embodiment of the present disclosure;

FIG. 6 is a flowchart specifically illustrating an operation of deriving a first error likelihood score according to an embodiment of the present disclosure;

FIG. 7, FIG. 8A and FIG. 8B illustrate a specific operation of a test code generation apparatus according to an embodiment of the present disclosure;

FIG. 9 is a flowchart illustrating a specific operation of a test code generation method according to an embodiment of the present disclosure; and

FIG. 10 illustrates the configuration of a computing device that generates a test code according to an embodiment of the present disclosure.

### DETAILED DESCRIPTION OF THE EXEMPLARY EMBODIMENTS

Hereinafter, embodiments disclosed herein will be described in detail with reference to the accompanying drawings. Aspects, specific advantages, and novel features of the present disclosure will be more apparent from the following detailed description and exemplary embodiments in conjunction with the accompanying drawings.

The concepts of the terms or words used in the specification and claims are appropriately defined by the inventor to describe the disclosure in an optimal manner, and these terms and words should be interpreted as having meanings and concepts in accordance with the technical idea of the present disclosure, are only for describing embodiments, and should not be construed as limiting the present disclosure.

In assigning reference numerals to components, like or similar components are assigned like reference numerals regardless of reference numerals and redundant descriptions thereof will be omitted. As used herein, the terms “module” and “unit” for components are given or interchangeably used only for ease in writing the specification, do not themselves have distinct meanings or functions, and may refer to a software or hardware component.

In describing components of the present disclosure, when a component is expressed in a singular form, it should be understood that the component also includes a plural form unless otherwise specified. Terms “first,” “second,” and the like are used to distinguish one component from another component, but the components are not limited by these terms. It should be understood that when a component is connected or coupled to another component, the component may be connected or coupled to the other element via any other element interposed therebetween.

When a detailed description about related known technology is determined to make the gist of embodiments disclosed herein unclear in describing the embodiments disclosed herein, the detailed description will be omitted herein. In addition, it should be understood that the accompanying drawings are only for easy understanding of the embodiments disclosed herein, and technical ideas disclosed herein are not limited by the accompanying drawings but include all modifications, equivalents, or substitutes included in the spirit and technical scope of the present disclosure.

Hereinafter, illustrative embodiments of a method, apparatus, system, and computer program for generating a test code using hybrid analysis according to the present disclosure are described in detail with reference to the accompanying drawings.

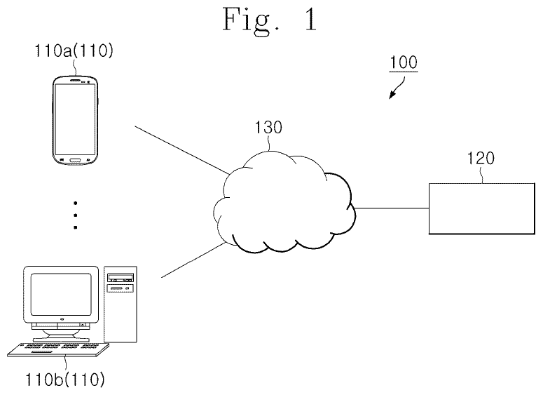

FIG. 1 illustrates the configuration and operation of a test code generation system 100 according to an embodiment of the present disclosure. As illustrated in FIG. 1, the test code generation system 100 according to the embodiment of the present disclosure may include one or more terminals 110a and 110b of a user and a test code generation apparatus 120 that is connected to the terminals 110a and 110b and generates a test code for a target program to be tested according to a request of the user.

The terminals 110a and 110b may include various terminals that allow the user to input or provide information necessary to generate the test code, such as a personal computer (PC), a laptop PC, a tablet PC, a smartphone, or a PDA, but the present disclosure is not necessarily limited thereto. Various devices, such as a server that has information about the target program, may also be used as the terminals 110a and 110b.

The test code generation apparatus 120 may be configured using one or more physical servers, but the present disclosure is not necessarily limited thereto. The test code generation apparatus 120 may also be configured using a personal computing device, such as a desktop computer, a laptop PC, a tablet PC, and a smartphone, configured based on a cloud system, or configured in various forms, such as a dedicated device.

The terminals 110a and 110b and the test code generation apparatus 120 may also be configured as being combined into a single server.

A network 130 connecting the terminals 110a and 110b and the test code generation apparatus 120 in FIG. 1 may include a wired network or a wireless network, and more specifically, various communication networks, such as a local area network (LAN), a metropolitan area network (MAN), and a wide area network (WAN). Further, the network 130 may also include the well-known World Wide Web (WWW). In addition, the network 130 may be configured using a data bus configured to transmit and receive data or the like.

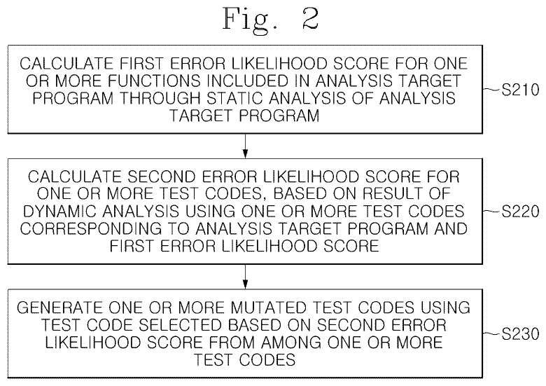

FIG. 2 is a flowchart illustrating a test code generation method according to an embodiment of the present disclosure.

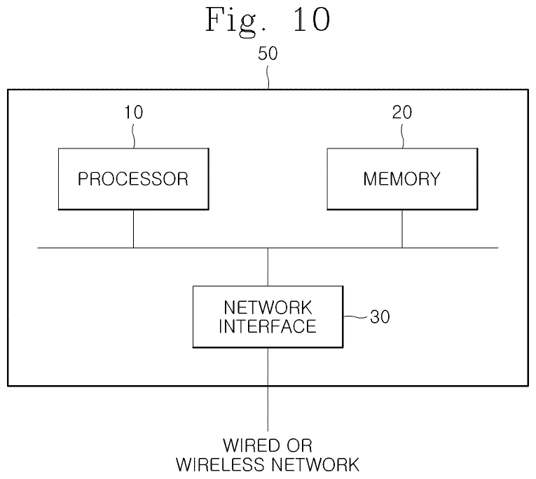

The method illustrated in FIG. 2 may be performed, for example, by the test code generation apparatus 120, and the test code generation apparatus 120 may be configured by including a computing device 50 described below with reference to FIG. 10. For example, the test code generation apparatus 120 may include a processor 10, and the processor 10 may execute an instruction configured to implement an operation of generating a test code for a target program.

More specifically, as illustrated in FIG. 2, the test code generation method according to the embodiment of the present disclosure is a method of generating a test code using the computing device 50, and may include operation S210 of calculating a first error likelihood score for one or more functions included in an analysis target program through static analysis of the analysis target program, operation S220 of calculating a second error likelihood score for one or more test codes, based on a result of dynamic analysis using the one or more test codes corresponding to the analysis target program and the first error likelihood score, and operation S230 of generating one or more mutated test codes using a test code selected based on the second error likelihood score from among the one or more test codes.

Operation S210 of calculating the first error likelihood score may include operation S211 of calculating one or more candidate paths for reaching a location of an expression likely to cause an error for the one or more functions, operation S212 of selecting a path likely to cause an error in which occurrence of an error is possible in a case of reaching the expression via the one or more candidate paths, and operation S213 of deriving the first error likelihood score for the one or more functions, based on the candidate paths and the path likely to cause the error.

Operation S211 of calculating of the one or more candidate paths may include operation S2111 of identifying the expression likely to cause the error for the one or more functions and operation S2112 of deriving the one or more candidate paths for reaching the location of the expression likely to cause the error, based on a control flow graph (CFG) for the analysis target program.

Operation S211 of deriving the one or more candidate paths may derive the one or more candidate paths by tracing the control flow graph backwards, based on the location of the expression likely to cause the error.

Operation S212 of selecting the path likely to cause the error may select the path likely to cause the error by determining whether an error occurs while executing each statement along the one or more candidate paths.

Operation S213 of deriving the first error likelihood score may include operation S2131 of calculating a path-based error likelihood score for the one or more functions, based on a ratio of the path likely to cause the error among the candidate paths and operation S2132 of calculating the first error likelihood score for the functions by adding the path-based error likelihood score for the one or more functions and a path-based error likelihood score for a called function called from the functions.

Operation S220 of calculating the second error likelihood score may calculate the second error likelihood score by adding respective first error likelihood scores for one or more functions called from the dynamic analysis using the one or more test codes.

Operation S230 of generating the mutated test codes may generate the mutated test codes selected with a high probability in proportion to the second error likelihood score for each of the one or more test codes.

Operation S230 of generating the mutated test codes may identify a variable or a statement associated with error occurrence through static analysis of the one or more test codes, and may generate the mutated test codes by selecting the identified variable or statement based on a probability.

Operation S230 of generating the mutated test codes may repeatedly generate the mutated codes, based on the second error likelihood score by repeatedly performing dynamic analysis based on the mutated test codes.

Accordingly, a method, apparatus, system, and computer program for generating a test code by using hybrid analysis according to an embodiment of the present disclosure may efficiently generate a test code for detecting a vulnerability of an analysis target program, may resolve stagnation or deterioration in vulnerability detection capability for an error, such as a null pointer exception (NPE), even though code coverage increases, and may efficiently detect a vulnerability of an analysis target program by using static analysis and dynamic analysis at the same time.

Hereinafter, the configuration and operation of the test code generation system 100 according to an embodiment of the present disclosure will be described in more detail with reference to each drawing.

In operation S210, the computing device 50, such as the test code generation apparatus 120, calculates a first error likelihood score for one or more functions included in an analysis target program through static analysis of the analysis target program.

The analysis target program may include an atomic unit forming software, but the present disclosure is not necessarily limited thereto.

Static analysis refers to a technique for analyzing a target program to be analyzed in a source code or binary state without executing the program, and may specifically include an abstract interpretation technique and a data dependency technique, but the present disclosure is not necessarily limited thereto.

In the present disclosure, a first error likelihood score for a function may refer to a probability that a predefined error, such as an NPE error, occurs in the function. The specific configuration and operation of the present disclosure will be described below with reference to an NPE error, which is merely an embodiment of the present disclosure, and the present disclosure is not necessarily limited thereto.

In the present disclosure, a function may include a method and a procedure in addition to a general function used in programming languages, and may further include various forms of programming blocks that may cause an error, such as an NPE, when executed by being called or referenced.

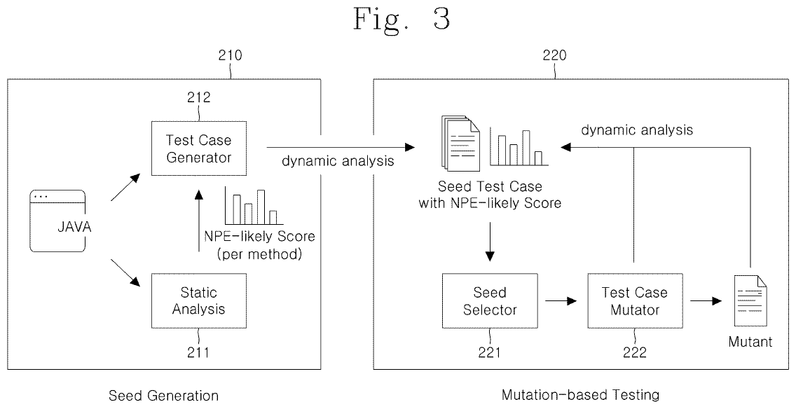

In a specific example, referring to FIG. 3, the test code generation apparatus 120 according to an embodiment of the present disclosure may be configured to include a seed generation block 210 and a mutation-based testing block 220.

As shown in FIG. 3, the seed generation block 210 may calculate the first error likelihood score, such as an NPE likelihood (e.g., an NPE-likely score (per method) of FIG. 3), for the one or more functions (specifically, a function, a method, or a procedure) included in the analysis target program through static analysis 211 of the analysis target program written in various programming languages, such as JAVA.

In operation S220, a second error likelihood score for one or more test codes is calculated based on a result of dynamic analysis using the one or more test codes corresponding to the analysis target program and the first error likelihood score.

In a specific example, as shown in FIG. 3, the one or more test codes corresponding to the analysis target program may be generated through a test code generator 212 of the seed generation block 210, and the one or more test codes and the second error likelihood score (e.g., a seed test case with NPE-likely score of FIG. 3) for the one or more test codes may be calculated through dynamic analysis of the one or more test codes.

In operation S230, one or more mutated test codes may be generated using a test code selected based on the second error likelihood score from among the one or more test codes.

In a specific example, as shown in FIG. 3, one or more test codes may be selected based on the second error likelihood score by using a seed selector 221 of the mutation-based testing block 220, and one or more mutated test codes (e.g., a mutant of FIG. 3) may be generated based on the one or more test codes by using a test code mutator 222.

Further, the mutation-based testing block 220 may repeatedly generate a mutated test case, based on the second error likelihood score by repeatedly performing dynamic analysis based on the mutated test case.

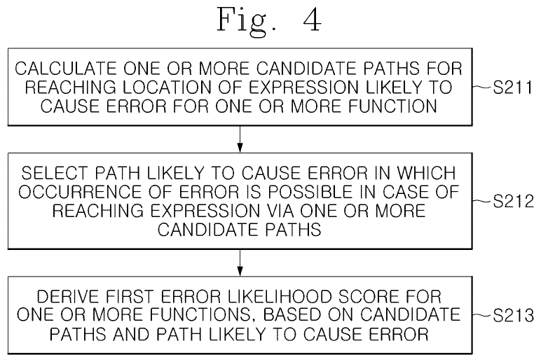

As shown in FIG. 4, operation S210 of calculating the first error likelihood score may include may include operation S211 of calculating one or more candidate paths for reaching a location of an expression likely to cause an error for the one or more functions, operation S212 of selecting a path likely to cause an error in which occurrence of an error is possible in a case of reaching the expression via the one or more candidate paths, and operation S213 of deriving the first error likelihood score for the one or more functions, based on the candidate paths and the path likely to cause the error.

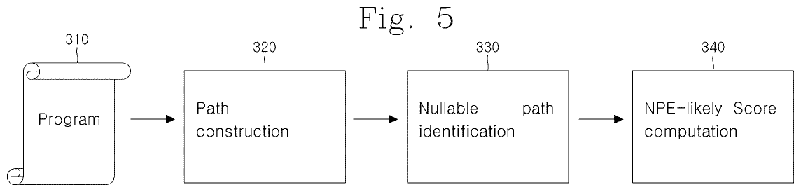

Specifically, as shown in FIG. 5, the seed generation block (210 of FIG. 3) may generate one or more candidate paths for reaching the location of an expression likely to cause an error for one or more functions of a given analysis target program 310 (320), may select a path likely to cause an error in which occurrence of an error is possible in a case of reaching the expression via the one or more candidate paths (330), and may derive a first error likelihood score for the one or more functions, based on the candidate paths and the path likely to cause the error (340).

Operation S211 of deriving the one or more candidate paths may derive the one or more candidate paths by tracing the control flow graph backwards, based on the location of the expression likely to cause the error.

Operation S212 of selecting the path likely to cause the error may select the path likely to cause the error by determining whether an error occurs while executing each statement along the one or more candidate paths.

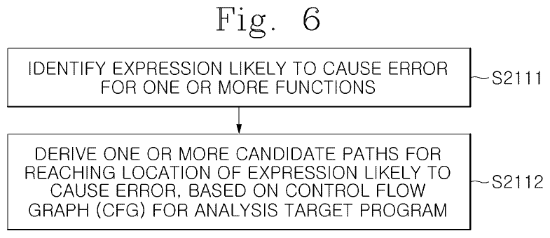

Further, as shown in FIG. 6, operation S211 of calculating of the one or more candidate paths may include operation S2111 of identifying the expression likely to cause the error for the one or more functions and operation S2112 of deriving the one or more candidate paths for reaching the location of the expression likely to cause the error, based on a control flow graph (CFG) for the analysis target program.

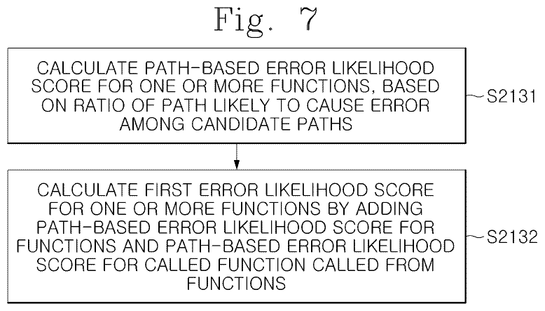

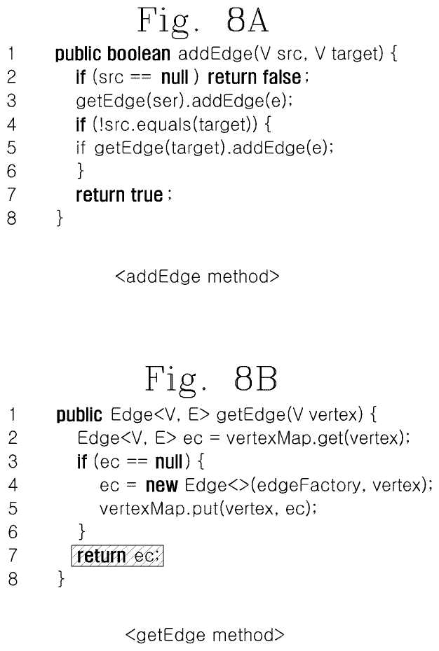

As shown in FIG. 7, operation S213 of deriving the first error likelihood score may include operation S2131 of calculating a path-based error likelihood score for the one or more functions, based on a ratio of the path likely to cause the error among the candidate paths and operation S2132 of calculating the first error likelihood score for the functions by adding the path-based error likelihood score for the one or more functions and a path-based error likelihood score for a called function called from the functions.

More specifically, in the present disclosure, a location where an NPE is likely to occur in the analysis target program may be identified through static analysis.

To explain the static analysis according to the present disclosure, symbols for the analysis target program are defined as follows.

S→x=E|return E|if E S S|while E S|S;S| (Definition 1)

E→new C( )|call(m)|assume(E)|n|null|x|E.E| (Definition 2)

Here, S may denote a statement, E may denote an expression, and x may denote a local variable or member variable of the analysis target program.

More specifically, Definition 1 defines a statement, which is a basic unit of the analysis target program, and may specifically include assignment of an expression for a variable, return of an expression, an if statement including an expression, a while statement, and a plurality of statement sequences.

Definition 2 defines an expression, and may specifically include a class constructor (e.g., new C( )), a call of a function (more specifically, a function, method, or a procedure), assumption of an expression, a numerical value n, null (null literal in a programming language), a variable (e.g., x), and a reference to a result value of another expression (e.g., E.E).

Accordingly, the test code generation apparatus 120 according to an embodiment of the present disclosure may first generate one or more candidate paths for reaching the location of an expression likely to cause an error for the one or more functions (path construction 320 of FIG. 5).

More specifically, the test code generation apparatus 120 may generate a control flow graph (CFG) for the analysis target program, and each node of the control flow graph (CFG) may be an atomic statement.

Further, the test code generation apparatus 120 may derive Tₑₓₚ(m), which is a set of target expressions and locations for function (more specifically, function, method, or procedure) m of the analysis target program, used to identify a path likely to cause an NPE by utilizing the generated control flow graph (CFG), in which case at least one of the following three conditions needs to be satisfied.
(Condition 1) Expression E for reference in an E1.E2 form (refer to a result value of another expression)
(Condition 2) Call of a function that calls a function in which an NPE is likely to occur (e.g., a function with at least one nullable path)
(Condition 3) Return variable with a return type of a reference type

The test code generation apparatus 120 classifies each function m of the analysis target program as a function unlike to cause an NPE, based on the set Tₑₓₚ(m) of expressions likely to cause an NPE when there is no expression satisfying condition 1 to condition 3 or when only condition 3 is satisfied.

Accordingly, the test code generation apparatus 120 may identify the Texp(m) for the function m, based on a condition that an expression is nullified or refers to null.

In a more specific example, Tₑₓₚ for an addEdge function(method) and a getEdge function(method), which are sample codes illustrated in FIGS. 8A and 8B, may be Tₑₓₚ(addEdge):{(getEdge(src), 3), (src, 4), (getEdge(target), 5)} and Tₑₓₚ(getEdge):{(vertexMap, 2), (vertexMap, 5), (ec, 7)}.

Subsequently, the test code generation apparatus 120 may calculate a path (sequence of statements) by tracing the control flow graph (CFG) backwards from each expression (i.e., exp) for the Tₑₓₚ(m).

According to a more specific identification method, the test code generation apparatus 120 may terminate constructing the path when reaching an expression satisfying one or more of the following conditions while tracing the control flow graph (CFG) backwards from the expression location (exp), and the following conditions may correspond to conditions for identifying a path in which each expression value may be null.
(Condition 11) Start point of a function
(Condition 12) Call of another function
(Condition 13) Call of a function with a side effect on the expression (exp)
(Condition 14) Definition corresponding to a variable used in the expression (exp) in a def-use chain
(Condition 15) Assume(E) for another expression (E) directly related to the expression (exp)

The test code generation apparatus 120 may construct the path for each expression in Tₑₓₚ(m) for the function m, and may store the path as a nullable candidate path in set (m, Infoₚₐₜₕ).

The test code generation apparatus 120 may select a path likely to cause an error that may result in a null occurrence when reaching the expression via the one or more of candidate paths (nullable path identification 330 of FIG. 5).

Here, the test code generation apparatus 120 may identify a path likely to cause an NPE from the nullable candidate path.

According to a more specific identification method, each candidate path of set (m, Infoₚₐₜₕ) may be sequentially identified using the following rule 1 to rule 5 that examine each statement, and the following rules may be configured to include all cases in which an NPE occurs after each path is executed.

θ(x=null,isNull)=isNull[x→true] (Rule 1)

θ(x=y,isNull)=isNull[x→isNull[y]] (Rule 2)

θ(x=new C( ),isNull)=isNull[x→false] (Rule 3)

θ(x=call(m′),isNull)=isNull[x→retₙᵤₗₗ(m′)] (Rule 4)

θ(assume(x==null),isNull)=isNull[x→true] (Rule 5)

In a more specific example, when a statement is x=null, the result of function rule 1 is isNull[x→true], which may mean that expression x is likely to be null. In this case, retₙᵤₗₗ(m) may output “true” in the presence of a path in which function m returns “null”, and may output “false” in the absence of the path.

The test code generation apparatus 120 may identify a null-likely path, based on the foregoing rules, and may classify a path as a path likely to cause an NPE when a result value is true after identifying up to the last statement in the path, thereby identifying nullable path mayNull(Set(m, infoₚₐₜₕ)) from set (m, Infoₚₐₜₕ) of the nullable candidate paths.

More specifically, in an example of FIGS. 8A and 8B, when assuming expression(ec, 7) as Tₑₓₚ(getEdge) for the getEdge function, the test code generation apparatus 120 may derive nullable paths (path1 and path2) such as path1→[ec=new Edge< >(edgeFactory, vertex); return ec] and path2→[!(ec==null); return ec].

Next, the test code generation apparatus 120 may derive a first error likelihood score for the one or more functions, based on the candidate paths and the paths likely to cause the error (NPE-likely score computation 340 of FIG. 5).

More specifically, after identifying the nullable paths, the test code generation apparatus 120 may calculate a probability that an NPE occurs for each function, based on the following equations.

$${S}_{path} ( m ) = \vert mayNull ( Set ( m , {Info}_{path} ) ) \vert / \vert ( Set ( m , {Info}_{path} ) \vert \qquad ( Equation 1 )$$

$${S}_{NPE} ( m ) = {S}_{path} ( m ) + {\sum }_{{m}^{′} ∈ φ ( m )} S\_NPE ( {m}^{′} ) \qquad ( Equation 2 )$$

In equation 1, mayNull(Set(m, Infoₚₐₜₕ)) denotes a set of paths likely to cause an NPE (nullable paths) among the paths identified by function m, which may be the ratio of paths likely to cause an NPE identified through nullable path identification (330 of FIG. 5) to the nullable path candidate set(m, infoₚₐₜₕ) constructed through path construction (320 of FIG. 5).

In addition, S_{NPE}(m), which is an NPE likelihood score for each function, defined in equation 2 may be calculated as the sum of a probability (Sₚₐₜₕ(m)) that an NPE occurs in each function m and a probability that an NPE occurs in all functions m′ called from function m.

That is, the sum of probabilities that an NPE occurs in all functions recursively called from function m may be calculated as the NPE likelihood score, in which case if the same function is recursively called a plurality of times, the score for the function may be added only once.

Accordingly, a function with an S_{NPE}(m) of 0 may be removed from an identification target.

Next, the test code generation apparatus 120 may calculate a second error likelihood score for one or more test codes, based on a result of dynamic analysis using the one or more test codes corresponding to the analysis target program and the first error likelihood score.

Further, the test code generation apparatus 120 may generate one or more mutated test codes using a test code selected based on the second error likelihood score from among the one or more test codes.

In addition, the test code generation apparatus 120 may repeatedly perform a process of synthesizing and executing the test codes for the analysis target program in a random and mutational manner, storing excellent tests (i.e., those that achieve high code coverage or detect an NPE) among the executed tests, and mutating the tests to generate an improved test code.

More specifically, the test code generation apparatus 120 may generate a test case by randomly combining statements that call and execute functionality of each function m included in the analysis target program.

More specifically, the test code generation apparatus 120 may store a set of functions called when executing a test code through dynamic analysis, and may calculate an S_{NPE}(m) score for each function m in the stored set.

The test code generation apparatus 120 may calculate a score indicating the likelihood of each test code causing an NPE (NPE score per test code) by adding the scores for the respective functions, based on the calculated scores, as illustrated below in equation 1.

That is, the test code generation apparatus 120 may calculate and consider not only the NPE score for each function but also the NPE score per test code.

$$S\_TC = {\sum }_{m ∈ method\_trace ( TC )} S\_NPE ( m ) \qquad [ Equation 1 ]$$

The test code generation apparatus 120 may select a test case with a higher score from among the test code candidates at a higher probability, based on the scores.

Accordingly, the test code generation apparatus 120 may mutate an expression and a statement that are highly likely to cause an NPE for the selected test code.

To this end, the test code generation apparatus 120 may identify a variable and a statement with data and control dependencies for a point where an NPE may occur in target function m derived through static analysis of each test code, and perform mutation of the variable and the statement with a higher probability.

Next, the test code generation apparatus 120 may additionally select a test code that achieves a coverage target (NPE detection or new code coverage) from a set of a mutated test code and an existing test code.

When performing dynamic analysis on each generated test code and then executing all NPE expressions identified through static analysis for each test target function, which means that all possible NPEs are identified, the test code generation apparatus 120 may remove a corresponding function from the test targets.

Accordingly, by focusing on dynamic analysis of a function with a remaining NPE not detected through a test code, resources may be saved and analysis may be performed more efficiently.

Further, the test code generation apparatus 120 may separately store and accumulate test codes that have detected an NPE.

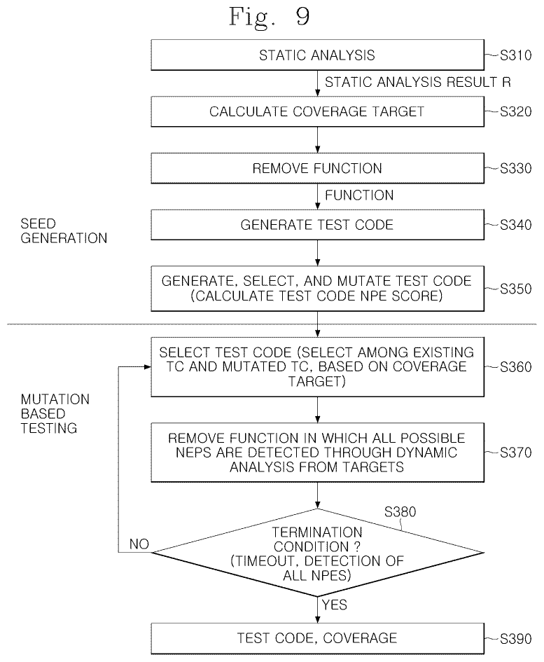

FIG. 9 is a flowchart specifically illustrating a test code generation method according to an embodiment of the present disclosure.

As shown in FIG. 9, the test code generation apparatus 120 may calculate Tₑₓₚ(m), which corresponds to a function likely to cause an NPE (including a functional argument closely related to an NPE-vulnerable area) and a code area (location), and S_{NPE}(m), which corresponds to an NPE likelihood score per function by performing static analysis of an analysis target program (S310).

Subsequently, the test code generation apparatus 120 may calculate a coverage target (S320).

More specifically, the test code generation apparatus 120 may calculate a target point likely to cause an NPE per function, based on Tₑₓₚ(m), and may perform dynamic analysis to generate a test code that achieves the target.

The test code generation apparatus 120 may remove a function that does not cause an NPE (S330).

The test code generation apparatus 120 may generate a test code by randomly combining statements that call and execute a function from the analysis target program (S340).

Next, the test code generation apparatus 120 may calculate an NPE score for the test code, and may generate, select, and mutate a test code (S350).

Furthermore, the test code generation apparatus 120 may select a test code, based on the coverage target from among the existing test code and the mutated test code (S360).

When executing all NPE expressions identified through the static analysis per test target function through the dynamic analysis, which means that all possible NEPs are detected, the test code generation apparatus 120 may remove a corresponding function from test targets (S370).

The test code generation apparatus 120 may determine whether a predetermined termination condition, such as a predetermined timeout or detection of all NPEs, is satisfied, and may terminate or repeat a test (S380).

Accordingly, the test code generation apparatus 120 may generate various mutated test codes and coverage results (S390).

The test code generation apparatus 120 may repeatedly perform operations S350 to S370 on the test code completely tested, thereby calculating the NPE score for the test code and selecting and mutating the test code.

Accordingly, the test code generation apparatus 120 may select a coverage target-based test code for the selected and mutated test codes, perform dynamic analysis, and then repeatedly perform a process of removing a function that causes NPE until a specific time or termination condition is satisfied, thereby accumulating and obtaining optimal test codes with a high likelihood of an NPE occurring.

The computer program according to another aspect of the present disclosure is a computer program stored in a computer-readable medium to execute a series of operations of the of the test code generation method in the test code generation system 100 in a computer. The computer program may be not only a computer program including a machine code generated by a compiler but also a computer program including a high-class language code executable in a computer using an interpreter. The computer is not limited to a personal computer (PC) or a laptop computer, but includes any information processing device including a central processing unit (CPU) and capable of executing a computer program, such as a server, a smartphone, a tablet PC, a PDA, or a mobile phone.

The computer-readable medium may keep storing a computer-executable program, or may temporarily store the computer-executable program for execution or download. Further, the medium may include various recording devices or storage devices in a form in which a single piece or a plurality of pieces of hardware is combined, and may be distributed on a network without being limited to a medium directly connected to a computer system. Therefore, the above detailed description should not be construed as restrictive in all aspects, and should be considered as illustrative. The scope of the present disclosure should be determined based on reasonable interpretation of the appended claims, and all changes and modifications within the equivalent scope of the present disclosure are included in the scope of the present disclosure.

A test code generation apparatus 120 according to an embodiment of the present disclosure is an apparatus for generating a test code that includes a processor and a memory, wherein the memory includes an instruction configured, when executed by the processor, to enable the apparatus to implement a specific operation, and the specific operation may include: calculating a first error likelihood score for one or more functions included in an analysis target program through static analysis of the analysis target program; calculating a second error likelihood score for one or more test codes, based on a result of dynamic analysis using the one or more test codes corresponding to the analysis target program and the first error likelihood score; and generating one or more mutated test codes using a test code selected based on the second error likelihood score from among the one or more test codes.

The test code generation apparatus 120 according to the embodiment of the present disclosure may be easily configured based on the foregoing description of the method, apparatus, and system for generating the test code made with reference to FIG. 1 to FIG. 9, and thus a redundant description is omitted and only key components are described below.

The calculating of the first error likelihood score may include: calculating one or more candidate paths for reaching a location of an expression likely to cause an error for the one or more functions; selecting a path likely to cause an error in which occurrence of an error is possible in a case of reaching the expression via the one or more candidate paths; and deriving the first error likelihood score for the one or more functions, based on the candidate paths and the path likely to cause the error.

The calculating of the one or more candidate paths may include: identifying the expression likely to cause the error for the one or more functions; and deriving the one or more candidate paths for reaching the location of the expression likely to cause the error, based on a control flow graph (CFG) for the analysis target program.

The deriving of the one or more candidate paths may derive the one or more candidate paths by tracing the control flow graph backwards, based on the location of the expression likely to cause the error.

The selecting of the path likely to cause the error may select the path likely to cause the error by determining whether an error occurs while executing each statement along the one or more candidate paths.

The deriving of the first error likelihood score may include: calculating a path-based error likelihood score for the one or more functions, based on a ratio of the path likely to cause the error among the candidate paths; and calculating the first error likelihood score for the functions by adding the path-based error likelihood score for the one or more functions and a path-based error likelihood score for a called function called from the functions.

The calculating of the second error likelihood score may calculate the second error likelihood score by adding respective first error likelihood scores for one or more functions called from the dynamic analysis using the one or more test codes.

The generating of the mutated test codes may identify a variable or a statement associated with error occurrence through static analysis of the one or more test codes, and may generate the mutated test codes by selecting the identified variable or statement based on a probability.

The generating of the mutated test codes may repeatedly generates the mutated codes, based on the second error likelihood score by repeatedly performing dynamic analysis based on the mutated test codes.

FIG. 10 illustrates an apparatus 50 to which the proposed method of the present disclosure is applicable.

Referring to FIG. 10, the apparatus 50 may be configured to implement a test code generation process in the test code generation system 100 according the proposed method of the present disclosure.

For example, the apparatus 50 to which the proposed methods of the present disclosure are applicable may include a network device such as a repeater, a hub, a bridge, a switch, a router, and a gateway, a computer device such as a desktop computer and a workstation, a mobile terminal such as a smartphone, a portable device such as a laptop computer, a home appliance such as a digital TV, and a transportation system such as a car. In another example, the apparatus 50 to which the present disclosure is applicable may be included as a part of an application-specific integrated circuit (ASIC) configured in the form of a system-on-chip (SoC).

A memory 20 may be operatively connected to a processor 10, may store a program and/or instructions for processing and control of the processor 10, and may store data and information used in the present disclosure, control information necessary to process data and information according to the present disclosure, and temporary data generated in a process of processing data and information. The memory 20 may be configured as a storage device, such as a read-only memory (ROM), a random access memory (RAM), an erasable programmable read-only memory (EPROM), an electrically erasable programmable read-only memory (EEPROM), a flash memory, a static RAM (SRAM)), a hard disk drive (HDD), and a solid state drive (SSD).

The processor 10 may be operatively connected to the memory 20 and/or a network interface 30, and controls the operation of each module in the apparatus 50. In particular, the processor 10 may perform various control functions for performing the proposed methods of the present disclosure. The processor 10 may also be referred to as a controller, a microcontroller, a microprocessor, a microcomputer, or the like. The proposed methods of the present disclosure may be implemented by hardware, firmware, software, or a combination thereof. When the present disclosure is implemented by using hardware, an application-specific integrated circuit (ASIC) a digital signal processor (DSP), a digital signal processing device (DSPD), a programmable logic device (PLD), a field programmable gate array (FPGA), and the like may be provided in the processor 10. When the proposed methods of the present disclosure are implemented by using firmware or software, the firmware or software may include instructions related to a module, a procedure, or a function that performs functions or operations necessary to implement the proposed methods of the present disclosure, and the instructions may be stored in the memory 20 or in a computer-readable recording medium (not shown) separately from the memory 20, and may be configured to cause the apparatus 50 to implement the proposed method of the present disclosure when executed by the processor 10.

The apparatus 50 may include the network interface device 30. The network interface device 30 may be operatively connected to the processor 10, and the processor 10 may control the network interface device 30 to transmit or receive a wireless/wired signal carrying information and/or data, a signal, a message, and the like through a wireless/wired network. The network interface device 30 supports various communication standards, for example, IEEE 802 standards, 3GPP LTE(-A), and 3GPP 5G, and may transmit and receive control information and/or a data signal according to the corresponding communication standards. The network interface device 30 may be configured outside the apparatus 50 as needed.

Accordingly, a method, apparatus, system, and computer program for generating a test code by using hybrid analysis according to an embodiment of the present disclosure may efficiently generate a test code for detecting a vulnerability of an analysis target program, may resolve stagnation or deterioration in vulnerability detection capability for an error, such as an NPE, even though code coverage increases, and may efficiently detect a vulnerability of an analysis target program by using static analysis and dynamic analysis at the same time.

The foregoing embodiments and drawings described herein are only for illustration, and are not intended to otherwise limit the scope of the present disclosure in any way. Connections of lines or connecting members between components shown in the drawings are intended to represent illustrative functional connections and/or physical or circuital connections, and may be present as alternative or additional various functional connections, physical connections, or circuital connections in a practical device. Moreover, no component may be essential to apply the present disclosure unless the component is specifically described as “essential” or “critical.”

As used in the specification of the present disclosure (especially in the claims), the term “the” and similar references are to be construed to cover both a singular form and a plural form. Furthermore, recitation of a range herein is merely intended to cover a disclosure employing each separate value falling within the range, and (unless otherwise indicated herein) each separate value is incorporated into the specification as if it were individually recited herein. In addition, operations presented in the methods of the present disclosure are not necessarily intended to be limited to the order of the operations, and the order may be appropriately changed as needed unless a certain operation needs to necessarily come first depending on the nature of each process. All examples or illustrative terms (e.g., “such as”) used herein are intended merely to explain the present disclosure in detail, and the scope of the present disclosure is not limited by the examples or illustrative terms unless limited by the claims. Further, those skilled in the art can understand that various modifications, combinations, and changes may be configured according to design conditions and elements within the scope of the appended claims or their equivalents.

What is claimed is:

1. A method for generating a test code using a computing device, the method comprising:
calculating a first error likelihood score for one or more functions included in an analysis target program through static analysis of the analysis target program;
calculating a second error likelihood score for one or more test codes, based on a result of dynamic analysis using the one or more test codes corresponding to the analysis target program and the first error likelihood score; and
generating one or more mutated test codes using a test code selected based on the second error likelihood score from among the one or more test codes.

2. The method of claim 1, wherein the calculating of the first error likelihood score comprises:
calculating one or more candidate paths for reaching a location of an expression likely to cause an error for the one or more functions;
selecting a path likely to cause an error in which occurrence of an error is possible in a case of reaching the expression via the one or more candidate paths; and
deriving the first error likelihood score for the one or more functions, based on the candidate paths and the path likely to cause the error.

3. The method of claim 2, wherein the calculating of the one or more candidate paths comprises:
identifying the expression likely to cause the error for the one or more functions; and
deriving the one or more candidate paths for reaching the location of the expression likely to cause the error, based on a control flow graph (CFG) for the analysis target program.

4. The method of claim 2, wherein the deriving of the one or more candidate paths comprises
deriving the one or more candidate paths by tracing the control flow graph backwards, based on the location of the expression likely to cause the error.

5. The method of claim 2, wherein the selecting of the path likely to cause the error comprises
selecting the path likely to cause the error by determining whether an error occurs while executing each statement along the one or more candidate paths.

6. The method of claim 2, wherein the deriving of the first error likelihood score comprises:
calculating a path-based error likelihood score for the one or more functions, based on a ratio of the path likely to cause the error among the candidate paths; and
calculating the first error likelihood score for the functions by adding the path-based error likelihood score for the one or more functions and a path-based error likelihood score for a called function called from the functions.

7. The method of claim 1, wherein the calculating of the second error likelihood score comprises
calculating the second error likelihood score by adding respective first error likelihood scores for one or more functions called from the dynamic analysis using the one or more test codes.

8. The method of claim 7, wherein the generating of the mutated test codes comprises
generating the mutated test codes selected with a high probability in proportion to the second error likelihood score for each of the one or more test codes.

9. The method of claim 1, wherein the generating of the mutated test codes comprises:
identifying a variable or a statement associated with error occurrence through static analysis of the one or more test codes; and
generating the mutated test codes by selecting the identified variable or statement based on a probability.

10. The method of claim 1, wherein the generating of the mutated test codes comprises
repeatedly generating the mutated codes, based on the second error likelihood score by repeatedly performing dynamic analysis based on the mutated test codes.

11. An apparatus for generating a test code, the apparatus comprising a processor and a memory,
wherein the memory comprises instructions configured to, when executed by the processor, enable the apparatus to implement specific operations, and
wherein the specific operations comprise:
calculating a first error likelihood score for one or more functions included in an analysis target program through static analysis of the analysis target program;
calculating a second error likelihood score for one or more test codes, based on a result of dynamic analysis using the one or more test codes corresponding to the analysis target program and the first error likelihood score; and
generating one or more mutated test codes using a test code selected based on the second error likelihood score from among the one or more test codes.

12. The apparatus of claim 11, wherein the calculating of the first error likelihood score comprises:
calculating one or more candidate paths for reaching a location of an expression likely to cause an error for the one or more functions;
selecting a path likely to cause an error in which occurrence of an error is possible in a case of reaching the expression via the one or more candidate paths; and
deriving the first error likelihood score for the one or more functions, based on the candidate paths and the path likely to cause the error.

13. The apparatus of claim 12, wherein the calculating of the one or more candidate paths comprises:
identifying the expression likely to cause the error for the one or more functions; and
deriving the one or more candidate paths for reaching the location of the expression likely to cause the error, based on a control flow graph (CFG) for the analysis target program.

14. The apparatus of claim 12, wherein the deriving of the one or more candidate paths comprises
deriving the one or more candidate paths by tracing the control flow graph backwards, based on the location of the expression likely to cause the error.

15. The apparatus of claim 12, wherein the selecting of the path likely to cause the error comprises
selecting the path likely to cause the error by determining whether an error occurs while executing each statement along the one or more candidate paths.

16. The apparatus of claim 12, wherein the deriving of the first error likelihood score comprises:
calculating a path-based error likelihood score for the one or more functions, based on a ratio of the path likely to cause the error among the candidate paths; and
calculating the first error likelihood score for the functions by adding the path-based error likelihood score for the one or more functions and a path-based error likelihood score for a called function called from the functions.

17. The apparatus of claim 11, wherein the calculating of the second error likelihood score comprises
calculating the second error likelihood score by adding respective first error likelihood scores for one or more functions called from the dynamic analysis using the one or more test codes.

18. The apparatus of claim 11, wherein the generating of the mutated test codes comprises:
identifying a variable or a statement associated with error occurrence through static analysis of the one or more test codes; and
generating the mutated test codes by selecting the identified variable or statement based on a probability.

19. The apparatus of claim 11, wherein the generating of the mutated test codes comprises
repeatedly generating the mutated codes, based on the second error likelihood score by repeatedly performing dynamic analysis based on the mutated test codes.

20. A computer-readable storage medium storing instructions configured to, when executed by a processor, enable an apparatus for generating a test code that comprises the processor to implement specific operations,
wherein the specific operations comprise:
calculating a first error likelihood score for one or more functions included in an analysis target program through static analysis of the analysis target program;
calculating a second error likelihood score for one or more test codes, based on a result of dynamic analysis using the one or more test codes corresponding to the analysis target program and the first error likelihood score; and
generating one or more mutated test codes using a test code selected based on the second error likelihood score from among the one or more test codes.
